(19) United States
(12) Patent Application Publication
(10) Pub. No.: US 2006/0116037 A1
(43) Pub. Date: Jun. 1, 2006

(54) Method and apparatus for monitoring boat decelelation during rowing

(76) Inventor: Charles Squires, Newton, MA (US)

Correspondence Address: TED PAULDING, 10 PENWOOD LA., WEST HERSFIELD, CT, 06109, US

(21) Appl. No.: 10/998,325

(22) Filed: Nov. 26, 2004

(51) Int. Cl. B63H 1/36; B63H 19/00; B63H 21/22; B63H 23/00; B60L 1/14

(52) U.S. Cl. 440/113; 440/1; 440/2

(57) ABSTRACT

The rowing measurement system provides methods and apparatus for improving the performance of a boat by measuring the effect of boat deceleration and providing in-boat feedback to the crew so they can minimize the effect. Specific boat data including speed, distance, stroke rate, acceleration and deceleration can be derived from the deceleration measurements. The data is then processed, displayed, and stored to memory to provide feedback on the boat and crew's performance to the rowers and coaches both in real time and for later analysis. The performance of the boat is measured by an accelerometer and timing device, providing basis for calculating speed, stroke rate, distance, and a deceleration factor without sensors external to the boat. The information on the rowers and the boat is then displayed in real time to the coxswain or head rower to provide immediate feedback on their performance. The data is stored at the CoxDisplay for transmission to the coach or communication to a computer for further display, analysis, communication, and charting a team's improvements.

### RELATED APPLICATIONS

Provisional Application U.S. 753,527, filed Nov. 26, 2003 entitled METHOD AND APPARATUS FOR DETERMINING ROWING PERFORMANCE OF A ROWER, hereby incorporated herein by reference. U.S. patent application Ser. No.______, filed of even date herewith, entitled METHOD AND APPARATUS FOR DETERMINING PERFORMANCE OF A ROWER, hereby incorporated herein by reference.

### BACKGROUND

Current in-boat mechanisms to capture boat performance are generally complex and require significant modifications to the boats. For example, the measurement of stroke rate is accomplished by attaching reed switches under the seats to detect a magnet on the seat. Turbines are added under the hull to measure boat speed. The turbines are difficult to install, must be adjusted, and are prone to breakage and maintenance. Limitations to these other approaches are that they require extensive modifications to existing equipment, are difficult to calibrate, and require complex electrical hookups.

The unique features of the Rowing measurement system of the present invention are that with no boat modifications, or in water sensors, it measures stroke rate, distance, acceleration, deceleration, and velocity. The lack of in water sensors eliminates additional cabling and drag from the turbine on the boat. The rowing measurement system generates real-time in-boat display of data including measurements for boat velocity, stroke rate, stroke count, and deceleration, information not completly available on prior apparatus. This data can also be transmitted to the coach to provide him with real time data, and real time feedback to the rowers in the boat. This new design results in an apparatus that can be easily installed to consistently provide accurate and consistent data, previously not available with prior apparatus.

### SUMMARY

There remains an unmet need for an apparatus capable of consistently and accurately measuring the velocity, acceleration, deceleration, stroke rate, stroke count and distance, and displaying this data in-boat. In order to overcome the shortcomings of the prior art, such a system should be easily installable, and reliable, while altering the standard shell (boat) arrangement as little as possible.

Training and selection of boats in competitive rowing would be greatly improved if a boat's, as well as a team's performance could be measured, displayed in real time for in-boat feedback to the rowers, and stored for later analysis by coaches and rowers.

One feature of the Rowing measurement system, which is not available in the current sensor systems, is the capturing of deceleration data. The importance of the deceleration measurement (Rowing Unit of Deceleration or RUD), in that this number integrates and normalizes the deceleration after the oars are removed from the water and before the boat again accelerates at the catch (where the oars again enter the water) on a stroke-by-stroke basis. The better the rowers manage (spread out) the force of the return to the catch position, the less the boat will decelerate. The degree of synchronicity of the oars entering the water, and how fast they accelerate to the water will also have an effect on the RUD. This synchronicity is also a measured parameter (the steep force slope when the oar enters the water) obtained by analyzing the force curve, and can be captured and displayed on a stroke-by-stroke basis in boat or stored for later display and analysis.

The signal generated by force sensors used in this system may be combined with data from an in boat accelerometer to provide positive and negative acceleration data coincident with the force data. This acceleration data can also be integrated to determine coincident velocity and velocity integrated to determine coincident distance. These signals may then be displayed to the rower or coxswain on a CoxDisplay, transmitted to an off-boat display for the coach, or stored for later analysis.

The output from an accelerometer, which is embedded in the CoxDisplay, is also integrated during the recovery phase to provide; a single number on a stroke by stroke basis, representing the deceleration of the boat caused by the introduction of the oars into the water; speed of the boat, and distance. The minimization of this deceleration is important to efficient utilization of the rower's energy. The importance of the deceleration measurement (Rowing Unit of Deceleration or RUD), is that this number normalizes (0-99) the integration the deceleration over time after the oars are removed from the water and before the boat again accelerates at the catch (where the oars again enter the water) on a stroke-by-stroke basis. The better the rowers manage (spread out) the force of the return to the catch position, the less the boat will decelerate. The degree of synchronicity of the oars entering the water, and how fast they accelerate to the water will also have an effect on the RUD.

The RUD integration is normalized to a 0-99 number. The following table illustrates an example of the difference in performance:

| RUD | Performance Indicators |
|---|---|
| 0-24 | Low boat drag, excellent synchronicity, |
| | quick oar acceleration in the water |
| | Expert Level performance |
| 25-66 | Normal boat drag, good synchronicity, |
| | good oar acceleration |
| | Intermediate level performance |
| 67-99 | High boat drag or problems with |
| | synchronicity or slow oar acceleration |
| | Novice level performance |

The RUD indicator is an important way to quantify, and compare, a team's (e.g., boat's) performance, and to measure and track improvement in performance.

Software on a PC provides for the analysis and display of the rowing data captured by the in-boat system. This data can be shown on a stroke-by-stroke basis or as a progression over the entire race. The data can also be displayed overlapped with other data such as deceleration data, speed, or stroke rate. Further, the information can be automatically emailed to team members so that they can track their performance.

Embodiments of the invention are applicable to a variety of rowing apparatus including numerous types and styles of shells, as well as rowing simulators and other exercise machines.

### BRIEF DESCRIPTION OF THE DRAWINGS

The foregoing and other objects, features and advantages of the invention will be apparent from the following more particular description of embodiments of the invention, as illustrated in the accompanying drawings and figures in which like reference characters refer to the same parts throughout the different views. The drawings are not necessarily to scale, with emphasis instead being placed upon illustrating the embodiments, principles and concepts of the invention.

FIG. 1 illustrates a force per unit time graph, according to one embodiment of the invention.

FIG. 2 illustrates compiled acceleration, velocity, and force for a single rowing stroke, according to one embodiment of the invention.

FIG. 3 illustrates a rowing measurement display, according to one embodiment of the invention.

### DETAILED DESCRIPTION

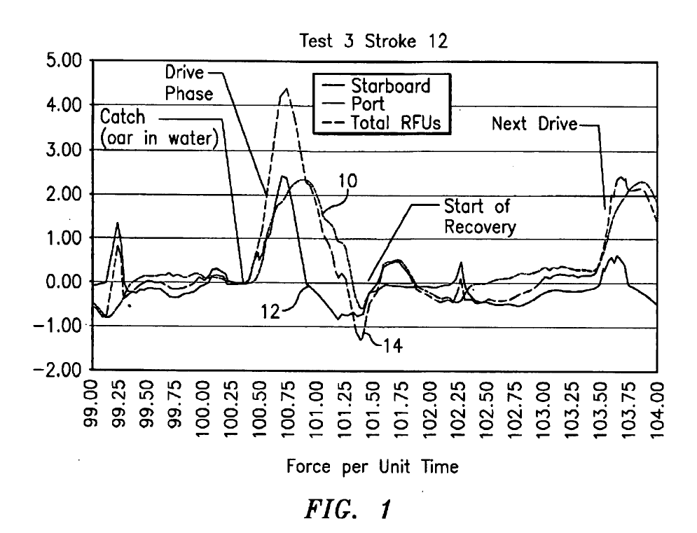

The Rowing measurement system provides in-boat measurements of the individual's and entire boat's performance, helping improve individual and team performance by providing immediate feedback on performance, and the insight into their performance to allow the coach to target areas to improve. Effective rowing is not just the magnitude of the application of force but the coordination, and technique related to the rower and team. Managing the energy during deceleration of the boat is critical to winning races, and currently no tools are available to provide this information to rowers or their coaches. The force per unit time graph (FIG. 1) provides wide-ranging information on the rower's technique and effectiveness, such as start of stroke, relative port and starboard force and recovery time. This information is derived from the system of the present invention used in combination with the system of U.S. patent application Ser. No.______, filed of even date herewith, entitled METHOD AND APPARATUS FOR DETERMINING PERFORMANCE OF A ROWER, hereby incorporated herein by reference.

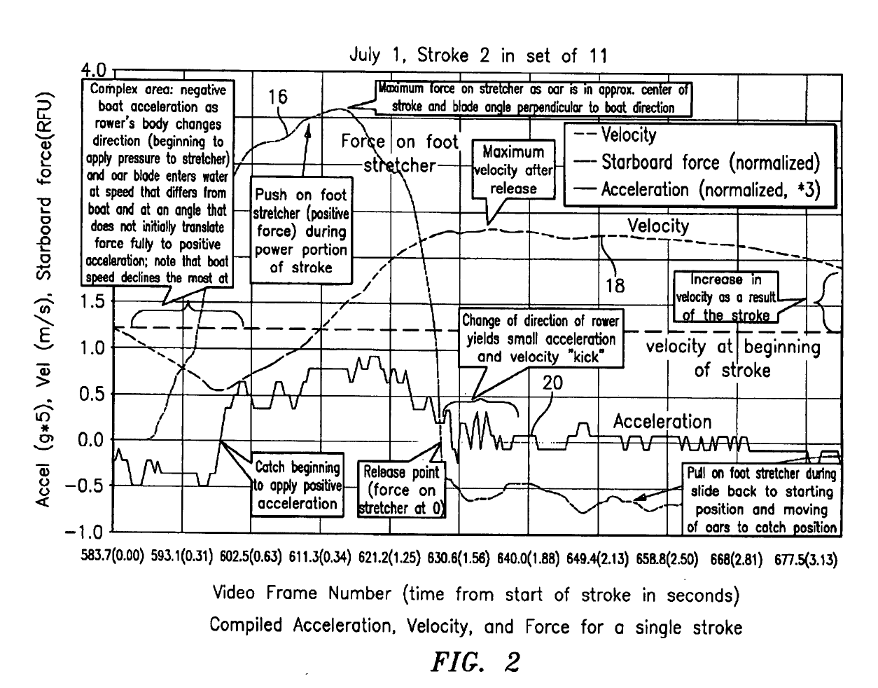

In FIG. 1, line 10 is the output from the starboard force sensor; line 12 is the output from the port sensor of the above-mentioned application and line 14 sums the force from the two sensors reflecting the total×direction force. You can easily see the “drive”, and recovery phase of the stroke. The blip in the force during the recovery (FIG. 1 time 101.75) is caused by the rowers body momentum driving the boat as they return to the catch position. The effect of this can be seen on the velocity profile in FIG. 2, in that the highest velocity occurs after the oars are removed from the water, and during the rower's return to the catch position.

FIG. 2 illustrates the interaction between the force the rower exerts at 16, the acceleration 18, and the velocity 20 of the boat. The deceleration measurement (Rowing Unit of Deceleration or RUD) is the number that captures the integration of the deceleration after the oars are removed from the water and before the boat again accelerates at the catch. The better the rower manages (spreads out) these forces during the return to the catch position, the less the boat will decelerate. The return force would not be captured if the force sensing were measured for example on the oar locks.

The velocity lost during the deceleration, which the RUD measures on a stroke-by-stroke basis, has to be regained during the next stroke to keep the velocity constant. The less the deceleration the less energy needed to maintain constant velocity. Other factors that contribute to the RUD is the drag of the boat in the water and air, synchronicity of the oars entering and leaving the water and the speed at which the oar matches the relative speed of the water.

The RUD information, along with the force, velocity, acceleration provides in-boat feedback to the rower or coxswain (e.g., indicates individual rower performance or performance of the boat overall).

A stroke is determined by the large positive change is acceleration at the catch. Stroke rate is determined by calculating the number of strokes per minute.

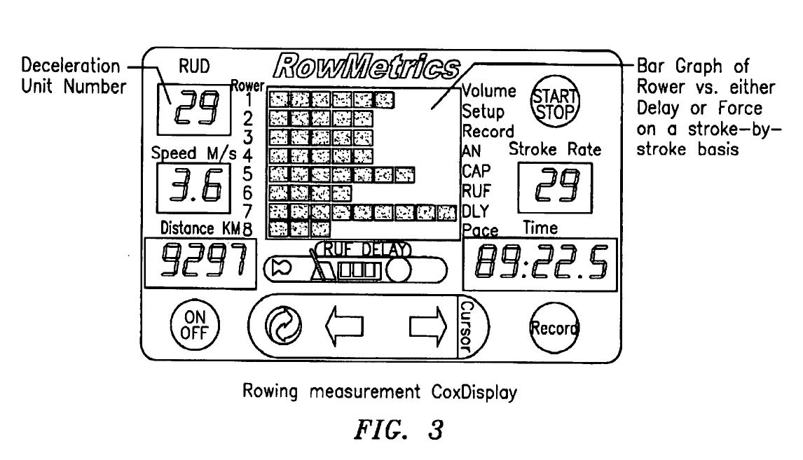

Signals are processed and may be displayed singly as port and starboard force graphs, or summed as a single force and displayed as a bar graph for each rower as illustrated in FIG. 3. The display also shows distance and speed (calculated from the accelerometer), time from an onboard clock, and stroke rate, calculated from processed accelerometer data. The center bar graph can either display the force from each rower during a stroke, or the relative delay of oar entering the water at the catch for each rower. The CoxDisplay can also show the integrated deceleration (RUD) of the boat during the catch part of the cycle.

The delay bar graph also indicates the synchronicity of the team. Coaching to increase the synchronicity (reduce delay) of the team will reduce the RUD (deceleration), resulting in better energy management, and better performance from the team.

Integrating speed and distance from the accelerometer provides an advantage to the boat over the existing method of determining speed from the rotational rate of a turbine speed sensor in the water, in that there is no external component, no speed sensor dragging in the water, no calibration, and no wires to run or sensor to tape onto the boat.

The information from all the sensors in the boat can be stored in the CoxDisplay for later transfer to a computer over a serial (RS232) line.

The acceleration signal can be displayed as an in analog or digital signal to each individual rower and/or collectively to the rower(s), coxswain or coach as desired. The real time output of the acceleration can be presented as instantaneous value, i.e., directly as a function of time, or as averages taken sequentially over one or more strokes. In addition to the real time presentation, the data can be stored in a solid-state memory device for subsequent review and analysis. The analysis can be extended to the calculation of work and power if displacements and speed are known as with the addition of the accelerometer. Acceleration, force, and timing information provide extensive information for modification of the rower's technique such as the slope, peak and duration of the force in the drive phase of the stroke. Also, the acceleration of the boat analyzed by each individual rowers contribution of force. Force too soon on the foot stretcher before the drive can indicate that the rower is “rushing the slide” or returning with too great of force, and not letting the boat move under them.

In one arrangement, transmitting the data to the computer provides a powerful and flexible display media. The force display screen can be shown with the boat's acceleration and velocity, or deceleration shown with stroke delay, providing key information to the coach on where his team needs improvement.

1. A rowing measurement system comprising apparatus for measuring the effective force generated by a rower including a pair of force sensors mounted on opposite sides of a foot stretcher and means connected with the sensors and adapted to monitor output information regarding the forces read thereby, an accelerometer connected with said means and adapted to receive the force signals therefrom, computer means including algorithms determining the beginning and end of a rower's power stroke, and said computer means also including an algorithm to integrate and normalize deceleration.

2. A rowing measurement system as set forth in claim 1 wherein the system is incorporated in a rowing shell.

3. A rowing measurement system as set forth in claim 1 wherein an in-boat display is provided and is served by said accelerometer and computer means to provide a read out of at least part of the deceleration of the boat .

4. A rowing measurement system as set forth in claim 1 wherein the computer means calculates the stroke count from the information provided by the accelerometer.

5. A rowing measurement system as set forth in claim 1 wherein the computer means calculates the stroke rate.

6. A rowing measurement system as set forth in claim 1 wherein the computer means performs a double integration of the accelerometer output to display distance. out.

7. A rowing measurement system as set forth in claim 1 wherein the computer means performs an integration of the accelerometer output to provide a velocity read out.

8. A rowing measurement system as set forth in claim 1 wherein the computer means normalizes and scales the integration of the deceleration to provide a single number which indicates the boats deceleration over one of many syrokes.
